(19) United States
(12) Patent Application Publication
(10) Pub. No.: US 2014/0218190 A1
(43) Pub. Date: Aug. 7, 2014

(54) BRAKE INTENSITY LIGHT DISPLAY

(71) Applicant: Kevin Roy Prenger, White Pine, TN (US)

(72) Inventor: Kevin Roy Prenger, White Pine, TN (US)

(21) Appl. No.: 14/172,575

(22) Filed: Feb. 4, 2014

Related U.S. Application Data
(60) Provisional application No. 61/760,496, filed on Feb. 4, 2013.

(51) Int. Cl. B60Q 1/44

(52) U.S. Cl. CPC B60Q 1/444
USPC 340/479

(57) ABSTRACT

A braking display system attached to an automobile is provided. The automobile includes a braking system for stopping the automobile while the automobile is in motion. The braking system includes a brake pedal that is used to initiate the braking system. A user may apply a plurality of different intensity levels to the braking system using the brake pedal. An indicator is used to project a level of intensity that is applied to the braking system from the rear of the automobile.

### CROSS-REFERENCE TO RELATED APPLICATION

This application claims the benefit of priority of U.S. provisional application No. 61/760,496, filed Feb. 4, 2013, the contents of which are herein incorporated by reference.

### BACKGROUND OF THE INVENTION

The present invention relates to a braking system and, more particularly, to a brake intensity light display.

A brake light is a red light attached to the rear of a motor vehicle that lights up when the brakes are applied, serving as a warning to following drivers. The amount of pressure applied to the brake correlates with the amount of time it takes for the car to slow down. Currently, following drivers behind a braking car do not know how much pressure is being applied to the brakes. Therefore, the following driver must use their depth perception to estimate how much pressure they must apply to their brake in response to the braking car.

As can be seen, there is a need for a device for displaying the amount of pressure that is being applied to the brake.

### SUMMARY OF THE INVENTION

In one aspect of the present invention, a braking display system comprises: an automobile comprising a braking system for stopping the automobile while in motion, wherein the braking system comprises an activation component configured to initiate the braking system and comprising a plurality of levels of intensity applied to the braking system; and an indicator projected from at least the rear of the automobile, wherein the indicator indicates a level of intensity that is applied to the braking system.

These and other features, aspects and advantages of the present invention will become better understood with reference to the following drawings, description and claims.

### BRIEF DESCRIPTION OF THE DRAWINGS

FIG. 1 is a rear view of the present invention shown in use demonstrating 25% brake pressure application;

FIG. 2 is a rear view of the present invention shown in use demonstrating 50% brake pressure application;

FIG. 3 is a rear view of the present invention shown in use demonstrating 75% brake pressure application; and

FIG. 4 is a rear view of the present invention shown in use demonstrating 100% brake pressure application.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a brake intensity light display. The present invention may be an extension to the third brake light that may run all the way across the rear window of a vehicle or the roof line of a truck. The light bar may be a series of red light emitting diodes (LED) that display to a following driver the brake intensity of the driver that is braking. The light bar may light up from the outside in towards the middle of the rear wind shield or any uniformed direction, such as from top to bottom, outside to inside, and the like.

The intensity of the braking may be displayed in multiple increments. For example, a driver that is slowing a small amount, the light bar may turn on 25% of the red LEDs. For a user that is applying a little more pressure, about 50% of the LEDs may turn on. When additional pressure is applied, about 75% of the Red LEDs may turn on. When the maximum amount of pressure is applied, the entire bar may light up with 100% of LEDs. This may indicate to a following driver that the braking driver is slamming on their brakes. The percentages may correlate with the percentage of pressure that is applied to the brake.

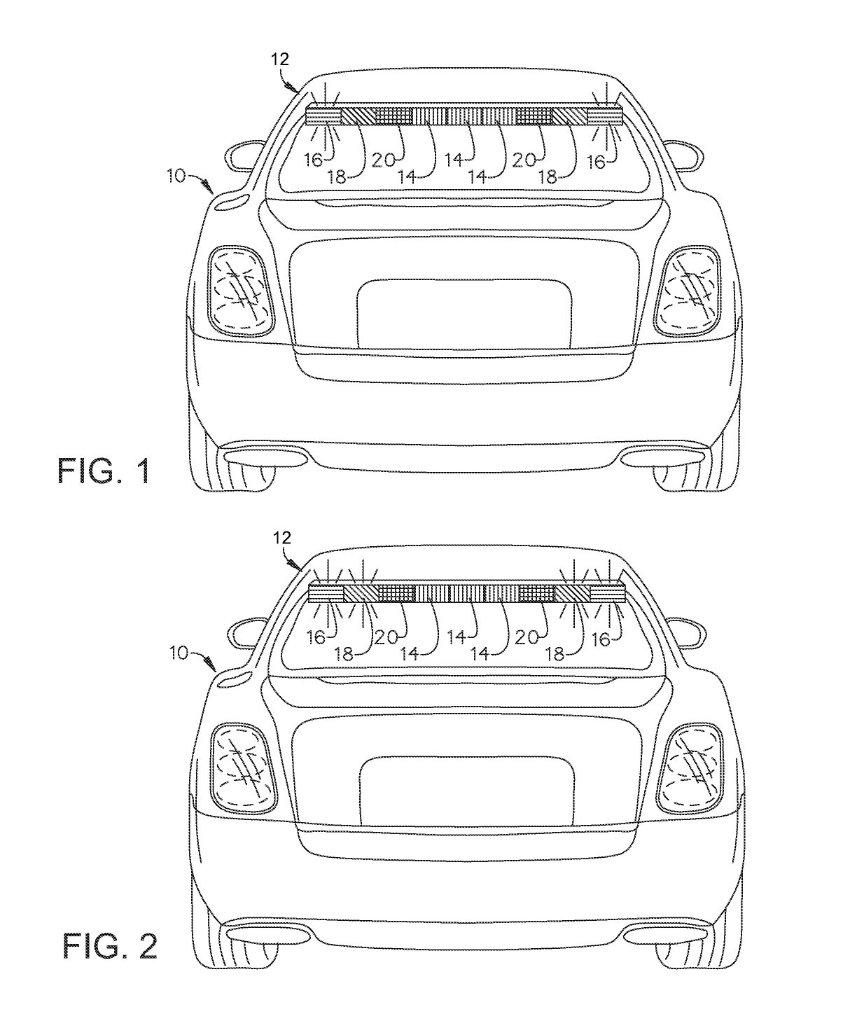

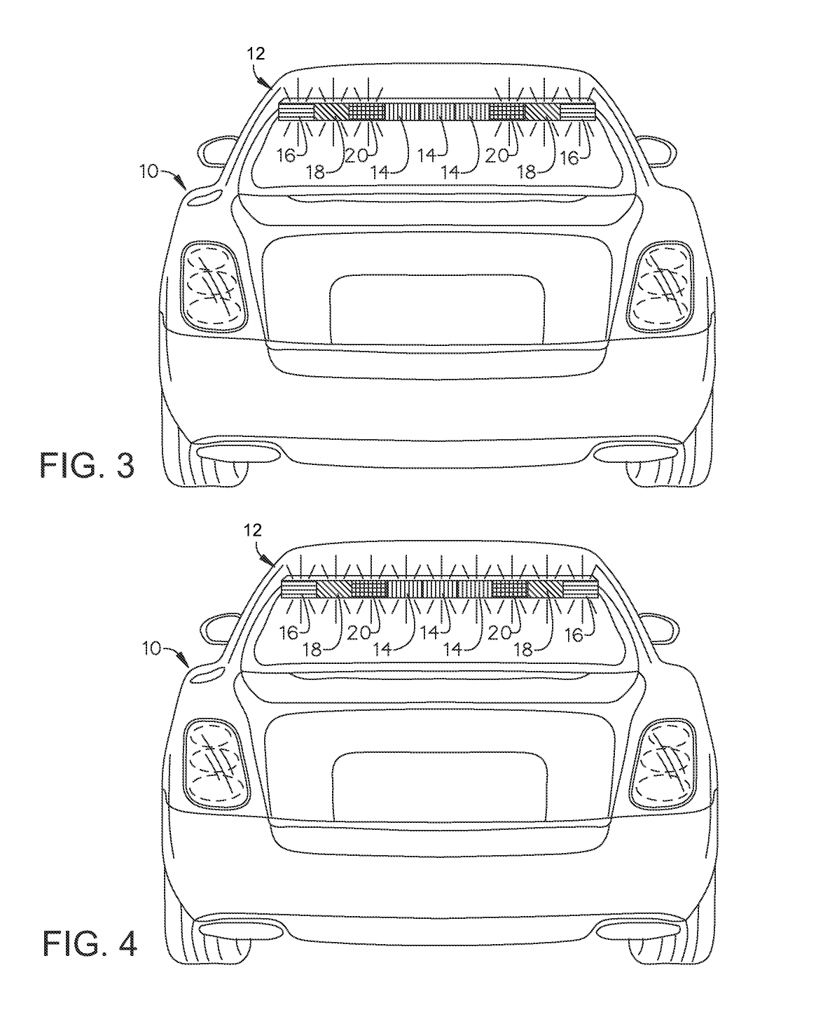

Referring to FIGS. 1 through 4, the present invention may include a braking display system attached to an automobile 10. The automobile 10 includes a braking system for stopping the automobile while the automobile is in motion. The braking system includes an activation component that is used to initiate the braking system. A user may apply a plurality of different intensity levels to the braking system using the activation component. In certain embodiments, the activation component is a brake pedal and the plurality of levels of intensity applied to the braking system includes amounts of pressure applied to the brake pedal. An indicator is used to project a level of intensity that is applied to the braking system from at the rear of the automobile 10.

In certain embodiments, the indicator includes a light display 12 having a plurality of lights. However, the indicator may be any known indication device in the art. The plurality of levels of intensity may include a range from low intensity to high intensity. In such embodiments, the amount of the plurality of lights is turned on incrementally from the low intensity to the high intensity. In certain embodiments, the light display 12 is a light emitting diode (LED) bar. The light emitting diode bar may include an outer portion of lights 16 leading to an inner portion of lights 14. The outer portion of lights 16 turn on at a low level of intensity, and the lights leading to the inner portion of lights 14 turn on as the intensity increases, and the inner portion of lights 16 turns on at a highest level of intensity.

In certain embodiments, the light bar may include the outer portion of lights 16, a second level of lights 18, a third level of lights 20, and the inner portion of lights 14. The inner portion of lights 14 may include a first inner portion and a second inner portion. The first inner portion may light up anytime the user initiates the brakes. In certain embodiments, the outer portion of lights 16 indicates a 25% intensity level, the second level of lights 18 indicates a 50% intensity level, the third level of lights 20 indicates a 75% intensity level, and the second inner portion of the inner portion of lights 14 indicates a 100% intensity level.

The present invention may include a plurality of lights 14 that are red LED lights. However, in certain embodiments, the plurality of lights 14 may include a plurality of different colors. For example, the outer portion of lights 16 may include a set of blue lights, the second level of lights 18 may include a set of green lights, the third level of lights 20 may include a set of yellow lights and the inner portion of lights 14 may include red lights.

In certain embodiments the present invention may include an electrical sensor connected with the braking system. The electrical sensor may send the electronic pulse of the pressure being applied to the brakes. This signal then activates the plurality of lights and displays a correlation of an amount of pressure being applied. The light bar of the present invention reads the signal and illuminates the appropriate amount of lights/display that informs the driver behind how hard the driver is applying pressure on their brakes. For older vehicles not computerized, an electric sensor used on trailer brakes may be utilized with the present invention.

In alternate embodiments, the present invention may be used display messages to following drives. When the user is not applying the brakes, the user may input messages to the LED bar. In such embodiments, there may be preset messages and alternatively the user may input messages using their smart phone or other portable device.

It should be understood, of course, that the foregoing relates to exemplary embodiments of the invention and that modifications may be made without departing from the spirit and scope of the invention as set forth in the following claims.

What is claimed is:

1. A braking display system comprising:
an automobile comprising a braking system for stopping the automobile while in motion, wherein the braking system comprises an activation component configured to initiate the braking system, wherein the activation component comprises a plurality of levels of intensity applied to the braking system; and
an indicator projected from at least the rear of the automobile, wherein the indicator indicates a level of intensity that is applied to the braking system.

2. The braking display system of claim 1, wherein the indicator comprises a light display comprising a plurality of lights.

3. The braking display system of claim 2, wherein the plurality of levels of intensity comprise a range from a low intensity to a high intensity.

4. The braking display system of claim 3, wherein an amount of the plurality of lights are turned on incrementally from the low intensity to the high intensity.

5. The braking display system of claim 1, wherein the light display is a light emitting diode bar.

6. The braking display system of claim 5, wherein the light emitting diode bar comprises an outer portion of lights leading to an inner portion of lights, wherein the outer portion of lights turn on at a low level of intensity, wherein the lights leading to the inner portion of lights turn on as the intensity increases, and the inner portion of lights turn on at a highest level of intensity.

7. The braking display system of claim 6, wherein the light emitting diode bar comprises the outer portions of lights, a second level of lights, a third level of lights, and the inner portion of lights.

8. The braking display system of claim 7, wherein the outer portions of lights indicates a 25% intensity level, the second level of lights indicates a 50% intensity level, the third level of lights indicates a 75% intensity level, and the inner portion of lights indicates a 100% intensity level.

9. The braking display system of claim 8, wherein the light emitting diode bar comprises red lights.

10. The braking display system of claim 7, wherein the outer portion of lights comprises a set of blue lights, the second level of lights comprises a set of green lights, the third level of lights comprises a set of yellow lights and the inner portion of lights comprises red lights.

11. The braking display system of claim 5, wherein the light emitting diode bar is displayed from a rear windshield of the automobile.

12. The braking display system of claim 5, wherein the light emitting diode bar is configured to display a message.

13. The braking display system of claim 1, wherein the activation component is a brake pedal.

14. The braking display system of claim 13, wherein the plurality of levels of intensity applied to the braking system correlates with a plurality of amounts of pressure applied to the brake pedal.
